(19) United States
(12) Patent Application Publication
(10) Pub. No.: US 2008/0192654 A1
(43) Pub. Date: Aug. 14, 2008

(54) Method, Apparatus, and Computer Program Product for Implementing Infiniband Network Topology Simplification

(76) Inventors: Timothy Roy Block, Rochester, MN (US); Charles Scott Graham, Rochester, MN (US); Kris Marie Kendall, Hager City, WI (US)

Correspondence Address: IBM CORPORATION;ROCHESTER IP LAW DEPT 917, 3605 HIGHWAY 52 N, ROCHESTER, MN, 55901-7829, US

(21) Appl. No.: 11/673,028

(22) Filed: Feb. 9, 2007

(51) Int. Cl. H04L 12/28

(52) U.S. Cl. 370/257

(57) ABSTRACT

A method, apparatus and computer program product implement InfiniBand (IB) network topology simplification. A Subnet Manager (SM) of an IB subnet sends a subnet discovery request to each switch requesting the number of ports that are attached to the switch. Each of the switches and target channel adapters (TCAs) within the IB subnet includes a Subnet Management Agent (SMA). The Subnet Management Agent (SMA) of the receiving switch responds to the SM indicating a sufficient number of ports on the switch to support at least one port for each TCA. Each TCA supports at least two local IDs (LIDs).

### FIELD OF THE INVENTION

The present invention relates generally to the data processing field, and more particularly, relates to a method, apparatus and computer program product for implementing InfiniBand (IB) network topology simplification.

### Description of the Related Art

Input/output (I/O) networks, such as system buses, can be used for the processor of a computer to communicate with peripherals such as network adapters. However, constraints in the architectures of common I/O networks, such as the Peripheral Component Interface (PCI) bus, limit the overall performance of computers. As a result new types of I/O networks have been introduced.

One new type of I/O network is known and referred to as the InfiniBand (IB) network. The InfiniBand network replaces the PCI or other bus currently found in computers with a packet-switched network, complete with zero or more routers. A host channel adapter (HCA) couples the processor to a subnet, and target channel adapters (TCAs) couple the peripherals to the subnet. The subnet typically includes at least one switch, and links that connect the HCA and the TCAs to the switches. For example, a simple InfiniBand network may have one switch, to which the HCA and the TCAs connect through links.

FIG. 1 illustrates a conventional InfiniBand printed circuit board (PCB) for an I/O enclosure including a plurality of endnodes, such as HCAs & TCAs, a plurality of switches, and a pair of external IB ports for attachment to an IB subnet. Ports on endnodes, switches, and routers are connected in a point-to-point fashion by links. See InfiniBand Architecture Specification Volume 1 for more detail. FIG. 1 illustrates one way to reduce cost by directly linking multiple single port endnodes within an enclosure via printed circuit board (PCB) links using very simple embedded three port switches.

For an InfiniBand (IB) subnet, the Subnet Manager (SM) is responsible for initial discovery and configuration of the subnet. Tightly coupled with the SM is another InfiniBand component known as the Subnet Administrator (SA). The SA provides services to members of the subnet including access to configuration and routing information determined by the SM.

The capabilities of the SM and SA can be sophisticated: the SM and SA resolve all potential paths from all nodes with deadlock avoidance, the SM and SA support many optional features of the InfiniBand Architecture (IBA), the SM and SA provide quality of service (QOS) support, and the like.

Alternatively, capabilities of the SM and SA may be simplistic: the SM and SA only resolve simple shortest paths between nodes, only implement mandatory IBA functions, and provide no QOS support.

In an open heterogeneous environment with multiple vendors attached to the same subnet with little or no restriction on which vendors participate, or in a closed homogeneous environment restricted to a limited, controlled number of vendors, there is often a need to support the SMs and SAs from different vendors with different levels of sophistication. In order to support a wide variety of the SM and SA capabilities a subnet configuration should present to the SM and SA a simple or trivial subnet configuration.

Some hardware implementations by their nature create a nontrivial subnet. This is often because of requirements to reduce the number of external cables in a subnet, to preserve legacy implementations and existing software/firmware support, to provide additional fan-out behind a switch, to provide additional RAS capability, and the like.

One pervasive RAS requirement for the enterprise computing space is the requirement to provide redundant independent paths from one node in a fabric to another node to allow failover from one path to another. In addition, it is generally expected the failover will be fast and nondisruptive to the upper layers of a system.

Fast nondisruptive failover is provided by InfiniBand through a capability know as Auto Path Migration (APM). Because of hardware requirements for features such as fast nondisruptive failover with redundant independent paths, often provided in combination with other requirements listed above, the SM and SA must provide advanced and optional features and potentially require application specific customization. Hardware implementations that create nontrivial subnets; and therefore require a sophisticated, potentially customized, SM and SA; significantly reduce their market opportunities.

A need exists for an effective mechanism for implementing InfiniBand (IB) network topology simplification.

### SUMMARY OF THE INVENTION

Principal aspects of the present invention are to provide a method, apparatus and computer program product for implementing InfiniBand (IB) network topology simplification. Other important aspects of the present invention are to provide such method, apparatus and computer program product for implementing InfiniBand (IB) network topology simplification substantially without negative effect and that overcome many of the disadvantages of prior art arrangements.

In brief, a method, apparatus and computer program product are provided for implementing InfiniBand (IB) network topology simplification. A Subnet Manager (SM) of an IB subnet sends a subnet discovery request to a switch requesting the number of ports that are attached to the switch. Each of the switches and target channel adapters (TCAs) includes a Subnet Management Agent (SMA). The receiving switch Subnet Management Agent (SMA) responds to the SM indicating a sufficient number of ports on the switch to support at least one port for each TCA within the subnet. Each TCA supports at least two local IDs (LIDs).

In accordance with features of the invention, the SM assigns at least two local IDs (LIDs) to each TCA. The SMA updates physical TCA hardware with the assigned LIDs for the TCA ports.

### BRIEF DESCRIPTION OF THE DRAWINGS

The present invention together with the above and other objects and advantages may best be understood from the following detailed description of the preferred embodiments of the invention illustrated in the drawings, wherein:

FIG. 1 illustrates a prior art InfiniBand (IB) PCB for an I/O enclosure using simple three port switches to provide target endnode expansion;

FIG. 2 illustrates an exemplary physical IB subnet for implementing InfiniBand (IB) network topology simplification in accordance with the preferred embodiment;

FIG. 3 illustrates a view of a Subnet Manager (SM) of the IB subnet of FIG. 2 in accordance with the preferred embodiment;

FIGS. 4, and 5 are diagrams illustrating IB network topology simplification operations of the apparatus of FIG. 2 in accordance with the preferred embodiment; and

FIG. 6 is a block diagram illustrating a computer program product in accordance with the preferred embodiment.

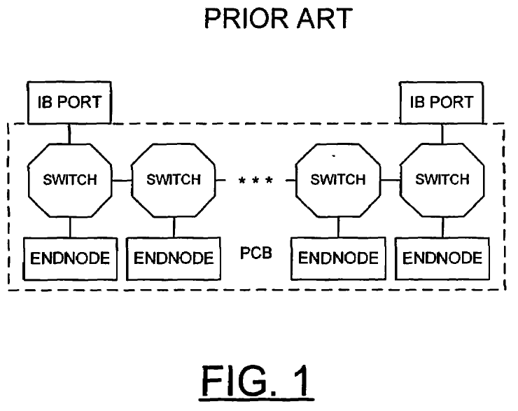

### DETAILED DESCRIPTION OF THE PREFERRED EMBODIMENTS

In an InfiniBand (IB) subnet, a Subnet Manager (SM) is responsible for initial discovery and configuration of the subnet. Another InfiniBand component is known as the Subnet Administrator (SA) that provides services to members of the subnet including access to configuration and routing information determined by the SM. As used in the following specification and claims, the term Subnet Manager (SM) should be understood to include the Subnet Administrator (SA).

In accordance with features of the preferred embodiments, methods are provided for implementing InfiniBand (IB) network topology simplification. This invention takes what would be a complex subnet and presents it to the SM as a simple subnet.

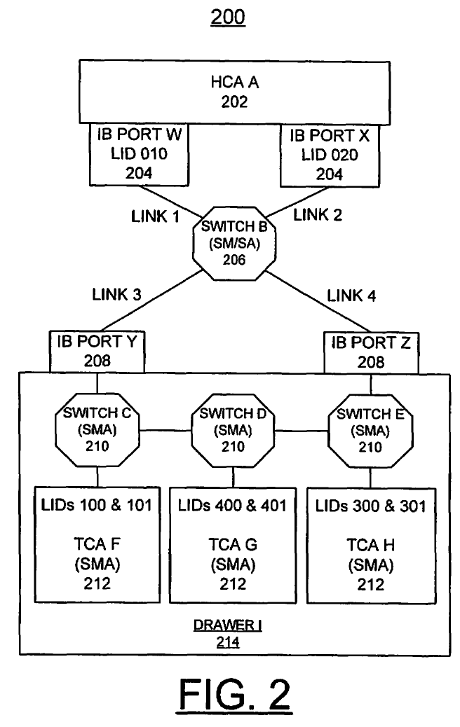

Having reference now to the drawings, in FIG. 2, there is shown an exemplary physical IB subnet generally designated by the reference character 200 for implementing InfiniBand (IB) network topology simplification in accordance with the preferred embodiment.

IB subnet 200 includes a host channel adapter (HCA A) 202 with a pair of IB ports W, X, 204, an external switch (switch B) 206, and a pair of IB ports Y, Z, 208, a plurality of embedded switches (switches C, D, E) 210 and a plurality of target channel adapters (TCAs F, G, H) 212 within an enclosure or drawer I, 214. The host channel adapter (HCA A) 202 couples a processor (not shown) to the IB subnet 200. The target channel adapters, (TCAs F, G, H) 212 within the drawer I, 214, couple peripherals (not shown) to the IB subnet 200.

It should be understood that the present invention is not limited to the switches and TCAs arranged within an enclosure as shown in accordance with the preferred embodiment, various other implementations are possible where the SMAs for the switches and TCAs are able to coordinate the processing of SM subnet discovery and configuration requests.

A first pair of point-to-point links, LINK 1, LINK 2 connects respective IB ports W, X 204 with the external switch B, 206. A second pair of point-to-point links, LINK 3, LINK 4 connects respective IB ports Y, Z, 208 with the external switch B, 206. Each of the embedded switches C, D, E, 210 is at least a three port switch.

Each of the switches C, D, E, 210, and TCAs F, G, H, 212 within the drawer includes a Subnet Management Agent (SMA) arranged for implementing InfiniBand (IB) network topology simplification in accordance with the preferred embodiment.

Redundant independent paths are needed within IB subnet 200. For example, with the configuration of IB subnet 200 as shown in FIG. 2, a path is needed from HCA A Port W, 204 through Drawer I Port Y, 208 to each of TCAs F, G, H, 212 and a redundant path from HCA A Port X, 204 through Drawer I Port Z, 208 to each of TCA F, G, H, 212. With these paths configured, HCA A, 202 has access to each of TCA F, G, H, 212 even if a link breaks.

A significant problem with this configuration typically results because a simple SM will only configure the shortest paths between two node ports. For the configuration in FIG. 2, a simple SM would only configure paths from Ports W, X, 204 of HCA A 202 to the port of TCA F 212 as follows: HCA A Port W through Drawer I, 214 Port Y to TCA F, and HCA A Port X through Drawer I Port Y to TCA F. In this example the link between Switch B and Drawer I Port Y or LINK 3 is common to both paths.

In accordance with features of the preferred embodiments, key elements include the following:

The SMA component for the nodes, switches and TCAs, in the drawer coordinates their responses to the SM in order to present a representation of the drawer topology that is different from what is physically inside the drawer.

The simple switches in Drawer I, 214, such as the illustrated Switches C, D, E, 210 in FIG. 2, must behave in one of the following two way: As an InfiniBand Architecture compliant switch with linear forwarding table support or as a very simple switch that checks a packet received on a port with the two Local IDs (LIDS) assigned by the SM to the TCA directly attached to the switch and, if it finds a match with one of the TCAs LIDs, routes the packet to the TCA. If the packet LID does not match one of the TCAs LIDs the packet is sent out the other switch port to the next switch.

The TCAs must support at least two LIDs.

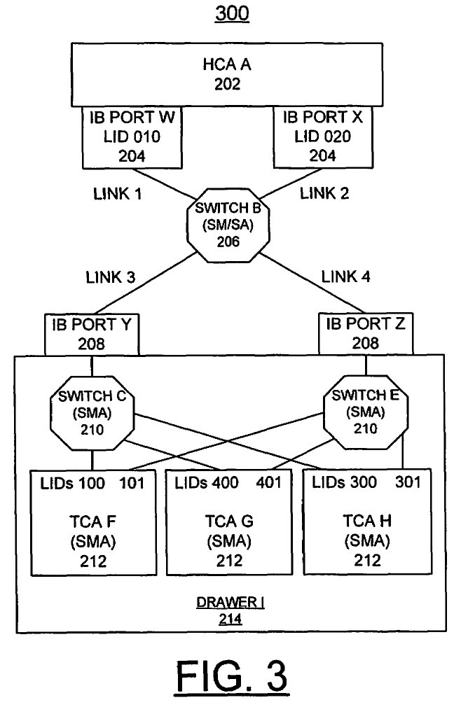

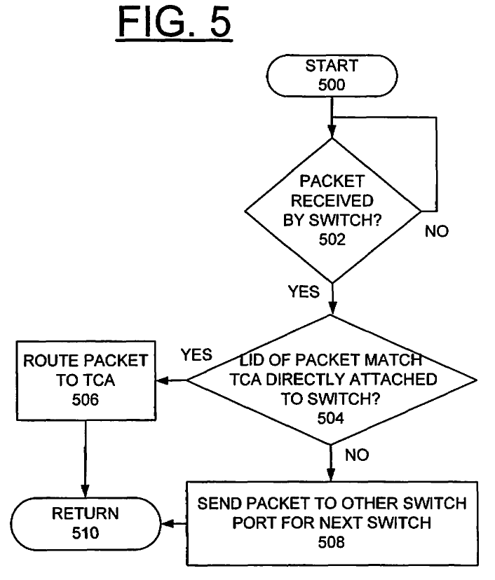

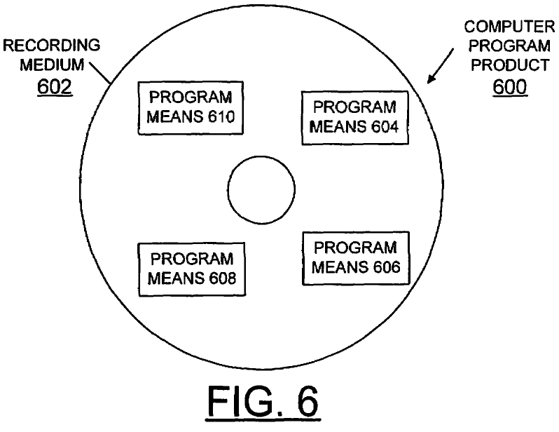

FIG. 3 illustrates how the SM of switch B 206 views the fabric for the hardware configuration in FIG. 2 when the techniques in accordance with the present invention are applied. FIGS. 5 and 6 illustrate exemplary steps of the methods for implementing InfiniBand (IB) network topology simplification in accordance with the preferred embodiment.

In FIG. 3, the drawer's Subnet Management Agents (SMAs), which are firmware components in each node that respond to requests of the SM of switch B 206 for node information, work in concert to present this view to the SM of switch B 206. In this IB network topology simplification view the SM of switch B 206 sees simple, equal length paths having the same number of node hops, from HCA A, 202 to TCAs F, G, H, 212. Because each of the TCAs F, G, H, 212 appear to the SM with two ports attached to different switches C, E, 210, even when implemented by a simple SM, the SM generates the desired independent paths. As an example, one path from HCA A, 202 to TCA F, 212 would flow from HCA A Port W, 204 through Drawer I Port Y, 208 to TCA F, 212 and the other path would flow from HCA A Port X, 208 through Drawer I Port Z, 208 to TCA F, 212. The fact one path is physically longer having more hops, is not a concern because the longer path is just a back up in case the primary path with fewer hops fails.

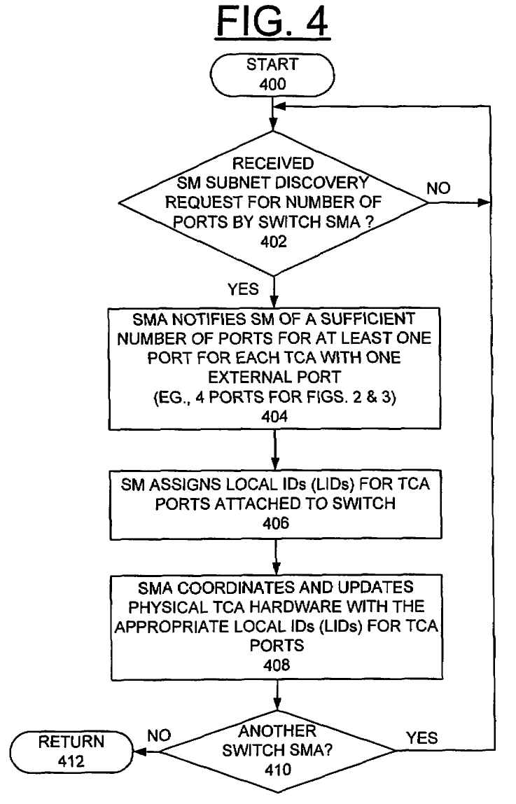

Referring to FIGS. 4, and 5, there are shown exemplary IB network topology simplification operations of the apparatus 200 of FIG. 2 in accordance with the preferred embodiment.

Referring now to FIG. 4, exemplary IB network topology simplification operations starting at block 400. When an SM performs subnet discovery, the SM asks switch C's SMA how many ports are attached to switch C. Checking for an SM subnet discovery request for a number of ports is performed by SMAs as indicated in a decision block 402. When the SM subnet discovery request for a number of ports is identified, the receiving switch SMAs, such as switch C's SMA must know there are three TCAs in the drawer in this example shown in FIG. 2, and respond to the SM indicating there are sufficient ports on the switch to support at least one port from each TCA as indicated in a block 404. In this example, SMA of switch C, 210 notifies the SM of switch B, 206 of a total of 4 ports on the switch C including 3 ports for each of the TCAs F, G, H, 212, and with 1 external port to Switch B.

Next as indicated in a block 406, the SM assigns LIDs to the TCA ports attached to Switch C, 210. Then the SMAs coordinate and update the physical TCA hardware with the appropriate LIDs as indicated in a block 408. As a result the physical routing works even though the actual physical hardware does not match the SM's view of the subnet topology.

With the appropriate LIDs assigned, when a packet arrives at switch C, 210 for LID 300 in FIG. 2, the packet is passed from switch C, 210 through switch D, 210 to switch E, 210 where it is then routed to TCA H as further illustrated and described in FIG. 5. The same steps and setup are provided when the SM configures the nodes attached to switch E, 210 except now when a packet flows into switch E, 210 it is checked for TCA H's LIDs first and then is passed on to the other switches only if the packet is not intended for TCA H, 212. With this invention the SM is not aware the additional routing is taking place and can easily configure independent redundant paths because the SM sees a much simpler fabric that is provided by the IB network topology simplification operations of the invention.

Then the exemplary steps are repeated when the next switch SMA is identified as indicated in a decision block 410. After the SM performs subnet discovery for each switch SMA, then the sequential operations return as indicated in a block 412.

Referring now to FIG. 5, exemplary IB network operations using the topology simplification start at block 500. A packet received by a switch in the drawer is identified as indicated in a decision block 502, such as switch C, 210. When a switch 210 in FIG. 2 supports a linear forwarding table (LFT) the SMAs configure the individual LFTs in the hardware so each switch forwards the packet out the appropriate port in accordance with the preferred embodiment.

If the switch in the drawer is an InfiniBand Architecture compliant switch with linear forwarding table support, or any very simple, the switch checks a packet received on a port with the two Local IDs (LIDs) assigned by the SM to the TCA directly attached to the switch as indicated in a decision block 504. If a match is found with one of the TCAs LIDs, the switch routes the packet to the TCA as indicated in a block 506. If the packet LID does not match one of the TCAs LIDs, the packet is sent out the other switch port to the next switch as indicated in a block 508. After the packed is routed to the TCA at block 506, or sent out the other switch port at block 508, then the sequential operations return as indicated in a block 510.

In brief, a significant advantage of method of the invention is that a very simple switch can be embedded within a TCA chip and multiple TCA chips can be cascaded in a drawer, requiring fewer physical cables and expensive external switches, without overly complicating the SM's view of the subnet while maintaining architecture compliance. This ability to manipulate the view presented to the SM allows for greater flexibility in hardware designs to allow for optimizations in performance and reliability without complicating the topology as viewed by the SM.

Referring now to FIG. 6, an article of manufacture or a computer program product 600 of the invention is illustrated. The computer program product 600 includes a recording medium 602, such as, a floppy disk, a high capacity read only memory in the form of an optically read compact disk or CD-ROM, a tape, a transmission type media such as a digital or analog communications link, or a similar computer program product. Recording medium 602 stores program means 604, 606, 608, 610 on the medium 602 for carrying out the methods for implementing InfiniBand (IB) network topology simplification of the preferred embodiment in the system 200 of FIG. 2.

A sequence of program instructions or a logical assembly of one or more interrelated modules defined by the recorded program means 604, 606, 608, 610, direct the IB subnet 200 for implementing InfiniBand (IB) network topology simplification of the preferred embodiment.

While the present invention has been described with reference to the details of the embodiments of the invention shown in the drawing, these details are not intended to limit the scope of the invention as claimed in the appended claims.

What is claimed is:

1. A method for implementing InfiniBand (IB) network topology simplification comprising the steps of:
providing a Subnet Management Agent (SMA) with each switch and each of a plurality of target channel adapters (TCAs) within an IB subnet;
providing each said TCA to support at least two local IDs (LIDs);
utilizing a Subnet Manager (SM), sending a subnet discovery request to a switch, said subnet discovery request to identify a number of ports attached to the switch; and
responding to said SM by said SMA of said receiving switch with a predefined number of ports including at least one port for each TCA within said IB subnet.

2. The method for implementing IB network topology simplification as recited in claim 1 further includes said SM assigning at least two local IDs (LIDs) to each said TCA.

3. The method for implementing IB network topology simplification as recited in claim 2 further includes said SMA updates physical TCA hardware with the assigned LIDs for each of the plurality of said target channel adapters (TCAs) within said IB subnet.

4. The method for implementing IB network topology simplification as recited in claim 3 further includes providing each said switch within said IB subnet with linear forwarding table support for routing packets to a selected one of the plurality of said target channel adapters (TCAs) within said IB subnet.

5. The method for implementing IB network topology simplification as recited in claim 3 further includes providing said switch within said IB subnet for checking assigned LIDs for a TCA attached to said switch for routing packets to a selected one of the plurality of said target channel adapters (TCAs) within said IB subnet.

6. The method for implementing IB network topology simplification as recited in claim 3 further includes responsive to a match of a packet LID with one of the assigned LIDs for the TCA attached to said switch, routing packets to the TCA attached to said switch.

7. The method for implementing IB network topology simplification as recited in claim 3 further includes responsive to packet LID not matching one of the assigned LIDs for the TCA attached to said switch, routing packets to a second switch port to a next switch within said IB subnet.

8. The method for implementing IB network topology simplification as recited in claim 1 further includes providing a switch with said Subnet Manager (SM), said switch connected between a host channel adapter (HCA) and an enclosure within said IB subnet.

9. The method for implementing IB network topology simplification as recited in claim 8 further includes providing at least two IB ports with said host channel adapter (HCA), and providing at least two IB ports with said enclosure.

10. The method for implementing IB network topology simplification as recited in claim 9 further includes a respective link between a respective one of a plurality of switch ports of said switch with said Subnet Manager (SM) and each said at least two IB ports provided with said host channel adapter (HCA) and each said at least two IB ports with said enclosure.

11. The method for implementing IB network topology simplification as recited in claim 10 further includes said SM configuring redundant independent paths between said host channel adapter (HCA) and each of said target channel adapters (TCAs) within said enclosure.

12. A computer program product for implementing InfiniBand (IB) network topology simplification in an IB network system including a host channel adapter connected by an external switch to an IB subnet including a plurality of switches and a plurality of target channel adapters (TCAs), each said TCA arranged to support at least two local IDs (LIDs); said computer program product including a plurality of computer executable instructions stored on a computer readable medium, wherein said instructions, when executed by a Subnet Management Agent (SMA) with the network system, cause the SMA to perform the steps of:
receiving a subnet discovery request from a Subnet Manager (SM), said subnet discovery request to identify a number of ports attached to the switch; and
responding to said SM with a predefined number of ports including at least one port for each TCA within said IB subnet.

13. A computer program product for implementing IB network topology simplification as recited in claim 12 further includes said SM assigning at least two local IDs (LIDs) to each said TCA.

14. A computer program product for implementing IB network topology simplification as recited in claim 13 further includes said SMA updating physical TCA hardware with said at least two assigned LIDs for each of the plurality of said target channel adapters (TCAs) within said IB subnet.

15. Apparatus for implementing InfiniBand (IB) network topology simplification in an IB network system including a host channel adapter connected by an external switch to an IB subnet, the IB subnet including a plurality of switches and a plurality of target channel adapters (TCAs); said apparatus comprising:
at least two local IDs (LIDs) supported by each of the plurality of TCAs;
a respective Subnet Management Agent (SMA) associated with each of said plurality of switches and each of a plurality of target channel adapters (TCAs);
a Subnet Manager (SM) sending a subnet discovery request to a receiving switch attached to an enclosure port, said subnet discovery request to identify a number of ports attached to the switch; and
said SMA of said receiving switch responding to said SM with a predefined number of ports including at least one port for each TCA within the IB subnet.

16. Apparatus for implementing IB network topology simplification as recited in claim 15 further includes at least two local IDs (LIDs) for each said TCA, said LIDs assigned by said SM.

17. Apparatus for implementing IB network topology simplification as recited in claim 16 further includes said SMA updating physical TCA hardware with said at least two assigned LIDs for each of the plurality of said target channel adapters (TCAs) within the IB subnet.

18. Apparatus for implementing IB network topology simplification as recited in claim 15 further includes each said switch within said enclosure providing linear forwarding table support for routing packets to a selected one of the plurality of said target channel adapters (TCAs) within the IB subnet.

19. Apparatus for implementing IB network topology simplification as recited in claim 15 further includes each said switch within said enclosure checking assigned LIDs for a TCA attached to said switch for routing packets to a selected one of the plurality of said target channel adapters (TCAs) within the IB subnet.

20. Apparatus for implementing IB network topology simplification as recited in claim 19 further includes each said switch, responsive to packet LID not matching one of the assigned LIDs for the TCA attached to said switch, routing packets to a next switch within the IB subnet.
